(19) United States
(12) Patent Application Publication
(10) Pub. No.: US 2022/0409457 A1
(43) Pub. Date: Dec. 29, 2022

(54) WHEELCHAIR FOOTRESTS

(71) Applicant: Animesh Anand, Ann Arbor, MI (US)

(72) Inventors: Aayana Anand, Ann Arbor, MI (US); Animesh Anand, Ann Arbor, MI (US)

(21) Appl. No.: 17/693,912

(22) Filed: Mar. 14, 2022

Related U.S. Application Data
(60) Provisional application No. 63/202,759, filed on Jun. 23, 2021.

(51) Int. Cl. A61G 5/12

(52) U.S. Cl. CPC A61G 5/128

(57) ABSTRACT

An improved set of wheelchair footrests comprising a right footrest and a left footrest; each footrest comprising a footrest arm and a footrest pedal: each footrest arm having a vertical portion, a top portion, and a bottom portion; the vertical portion being connected to the top portion on one end and to the bottom portion on the opposite end; the top portion of each footrest arm having a curved bracket configured to rotatably attach to a wheelchair's frame at a receiving bracket, said curved bracket being configured to rotate the footrest arm about the wheelchair's frame into a stowed position beneath the wheelchair, and said curved bracket also being configured to rotate and lock the footrest arm about the wheelchair's frame into an engaged position via a position locking mechanism; and the bottom portion of each footrest arm being coupled to the footrest pedal.

### CROSS REFERENCE TO RELATED APPLICATIONS

This application claims the benefit of U.S. Provisional Patent Application No. 63/202,759, filed Jun. 23, 2021, and titled “WHEELCHAIR FOOTREST IMPROVEMENT,” the contents of which are incorporated by reference in their entirety.

### FIELD OF THE INVENTION

The present invention relates to an improved set of wheelchair footrests including hingedly attached and locking footrest arms. More particularly, the present invention provides an improvement over traditional footrest arms by allowing the footrest to be rotated to an inward position and stowed beneath the seat of a wheelchair, locked into a usable position for a rider of the wheelchair, and/or be rotated to an outward position.

### BACKGROUND OF THE INVENTION

In the medical field, practitioners, clinicians, caretakers, and other professionals use several types of conveyances or conveyance devices to transport an infirm, geriatric, or patient from one location to another. One such device is the well-known wheelchair. Most modern wheelchairs include a chair on wheels that can be manually propelled, motor driven, or pushed by an assistant. Further, those wheelchairs typically include footrests for the rider to place their feet on to prevent injury or discomfort to their feet, ankles, legs, etc. These footrests may include footrest arms that can swivel, detach, have straps, lock into place, extend, and more.

Despite their abundance of use, some typical wheelchair footrests present challenges for many riders, practitioners, and facilities. One such problem is the swinging of unlocked footrests that swivel about from an engaged position outwards to the exteriors of the wheelchair. These footrests are typically made of metal, hard plastics, or other durable materials and the rotational swivel of a footrest can sometimes make contact with a rider or practitioner's body resulting in pain, potential bruising, or more. Another such problem is with storage of footrests in facilities such as long-term treatment centers, assisted living complexes, nursing homes, and other facilities which may require a plurality of wheelchairs and footrests which are configured to best suit a certain patient or body height and weight. Often in these facilities, practitioners, and other staff members will remove the detachable footrests from the wheelchair either to store those footrests or to replace them with another set of footrests. Footrests are easily swappable and can be adjusted for the height of the rider, but most wheelchairs are uniform, leaving it to the footrests to accommodate the comfort and safety of the rider. It may take a practitioner or facility employee more time than desirable to find footrests that have been detached for a particular patient. This results in a loss of time as well as potential patient injury in the event that no footrests or the wrong footrests are used. One common injury is the rider (typically someone who is geriatric or ill) misjudging their own capability and falling when attempting to exit a wheelchair without footrests.

### SUMMARY OF THE INVENTION

The following presents a simplified summary of the present invention to provide a basic understanding of the invention's concepts. This summary is not an extensive overview, and it is not intended to identify critical elements or to limit the scope of this discloser. The sole purpose of this summary is to present some general concepts in a simplified form as a prelude to the detailed description of the invention.

In some embodiments, the present invention provides a modification to traditional footrest arms that addresses the following challenges: most footrest solutions rotate outwards which results in an increase of the overall width of the wheelchair, making it harder to navigate through narrow hallways; footrests are easily removed users and, once removed, footrests may be hard to locate and the rider is often forced to sit on the wheelchair without footrests, this may cause falls and/or injury to the rider; and the users may have to spend time looking for footrests which takes them away from the caregiving and facility responsibilities. The current invention addresses all the above challenges because the present invention provides a modification to traditional footrest arms that allows the footrest arms to be rotated to an inward position and stowed beneath the seat of a wheelchair. In some embodiments of the present invention, this modification is an improved set of wheelchair footrests having a right footrest and a left footrest. Each footrest comprising a footrest arm and a footrest pedal (sometimes also referred to as a footrest plate). Each footrest arm having a vertical portion, a top portion, and a bottom portion. The vertical portion being connected to the top portion on one end and to the bottom portion on the opposite end. The top portion of each footrest arm having a curved bracket configured to rotatably attach to a wheelchair's frame at a receiving bracket, said curved bracket being configured to rotate the footrest arm about the wheelchair's frame into a stowed position beneath the wheelchair, and said curved bracket also being configured to rotate and lock the footrest arm about the wheelchair's frame into an engaged position via a position locking mechanism. Finally, the bottom portion of each footrest arm being coupled to the footrest pedal.

The present invention, in alternative embodiments, is a wheelchair that includes the innovation of the above footrest modification in a pair of footrests that are permanently affixed to the wheelchair.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 illustrates a view from above of an embodiment of the present invention attached to a conventional wheelchair.

FIG. 2 illustrates an isometric view of a footrest arm of a right footrest of one embodiment of the present invention.

FIG. 3 illustrates an above view of an embodiment of the present invention attached to a conventional wheelchair and in an engaged position.

FIG. 4 illustrates a closer view of the swivel and lock mechanisms of one embodiment of the current invention while in the engaged position.

FIG. 5 illustrates an above view of an embodiment of the present invention attached to a conventional wheelchair and in a stowed position.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a set of footrests that swivel about a frame of a wheelchair and are easily stowed beneath that wheelchair. This trait of the footrests will reduce the need for practitioners, clinicians, riders, and users to remove the footrests. In turn, this will also reduce the frequency of lost footrests that were detached for storage, particularly in healthcare and long-term care facilities. This availability and known location of footrests will reduce the occurrences of riders falling when using a wheelchair without footrests or with footrests that are not adjusted for that rider. Further, there is a long-felt need for a solution for keeping footrests attached to the wheelchair and not rotated to the exterior of that wheelchair while the wheelchair is not being used and such non-use does not warrant the disassembling or detaching of the footrests from the wheelchair. This solution saves space and reduces the chance of damaging property or injuring someone with exterior swinging footrests.

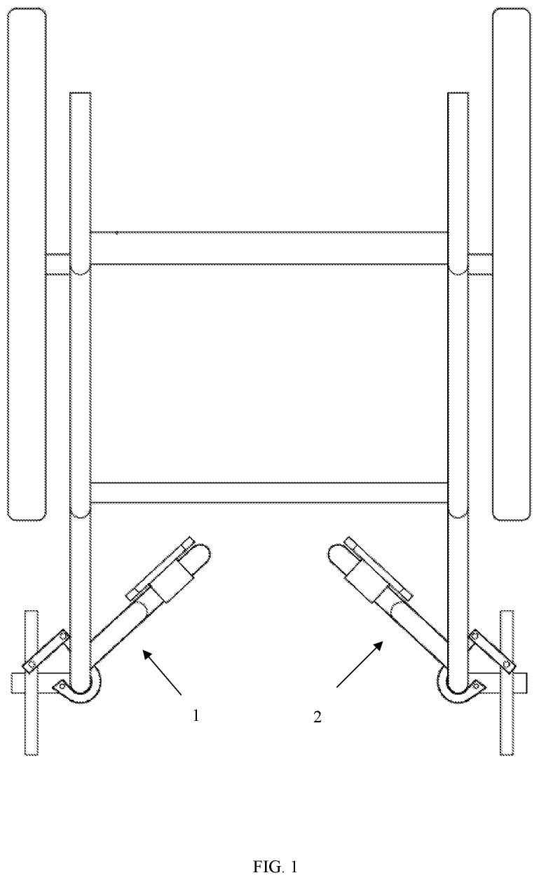

Referring to FIG. 1. In some embodiments, the present invention is a novel set of footrests including a right footrest 1 and a left footrest 2 (sometimes, individually, a “footrest;” and collectively, “footrests” or “set of footrests”). The pictured embodiment displays the set of footrests stowed beneath the wheelchair by swiveling the unique brackets inwards to a position well beneath the seat of the wheelchair. In this embodiment, the brackets are swivel beyond the 90 degrees of difference between an engaged position (allowing the rider to rest their feet on the footrests) and a stowed position (about 90 degrees inward from the engaged position such that the footrest arms align perpendicular to the forward direction of the wheelchair). This amount of swivel is due to the curvature of the brackets on the footrest arms and the receiving brackets on the wheelchair. In some embodiments, a locking mechanism may be employed to prevent the footrest arms from undesirably swiveling towards the engaged position, outwards, or beyond the desired stowed position.

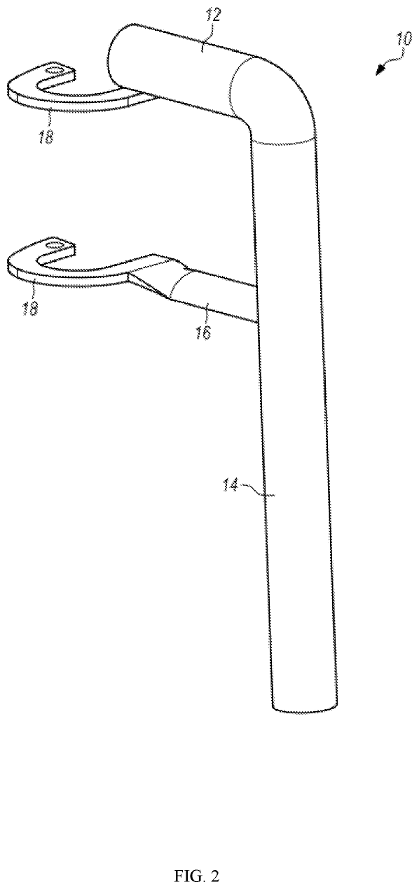

Referring to FIG. 2. In some embodiments, the present invention includes a footrest arm 10 having a top portion 12, a vertical portion 14, a secondary support bar 16, and at least one curved bracket 18 that engages with a receptacle or receiving bracket on a wheelchair frame to couple the footrest to that wheelchair. In some embodiments of the present invention, the top portion 12, vertical portion 14, and secondary support bar 16 may have adjustable lengths in order to accommodate a variety of wheelchairs and the rider's height and/or preferences. Such adjustable lengths may be accomplished by telescoping portions that are secured by a variety of methods known in the art such as hole and pin locking mechanisms, button-hole locking mechanisms (with one or two springed buttons), twisting expansion and compression mechanisms within the telescoping parts, ratcheting, or other methods that secure the portion or bar at a desired length. Ideally, any locking mechanism for the telescoping method of any footrest arm 10 ensures that, when locked, there is no noise, undesired movement, or risk of the locking mechanism releasing at an undesired time. The curved bracket 18 of the footrest arm 10 may be curved in such a way that, when moved to the stowed position, the curvature of the bracket allows for and accents the engaged portion of the wheelchair frame. For example, in some embodiments, the curved bracket 18 may be manufactured to rest flush with the metal tubular frame of the wheelchair and lock into the stowed position beneath the seat of the wheelchair. Additionally, there may be rubber or other suitable spacing members which prevent undesired metal-on-metal contact between the footrest arm or the curved bracket and the frame. The curved bracket 18 may connect to the wheelchair frame via a hole or other receptacle to receive a pin or plug located on a receiving bracket on the wheelchair. In some embodiments, the secondary support bar 16 may have its own curved bracket 18 that may be identical to the one attached to the top portion 12. In alternative embodiments, the curved bracket 18 attached to the secondary support bar 16 may lack any position locking mechanisms and only serve to stabilize the footrest arm 10 as it swivels about or is secured into a position relative to the wheelchair. The components of the footrest arm 10 may be made from suitable materials such as metal, plastics, wood, rubber, or some combination thereof.

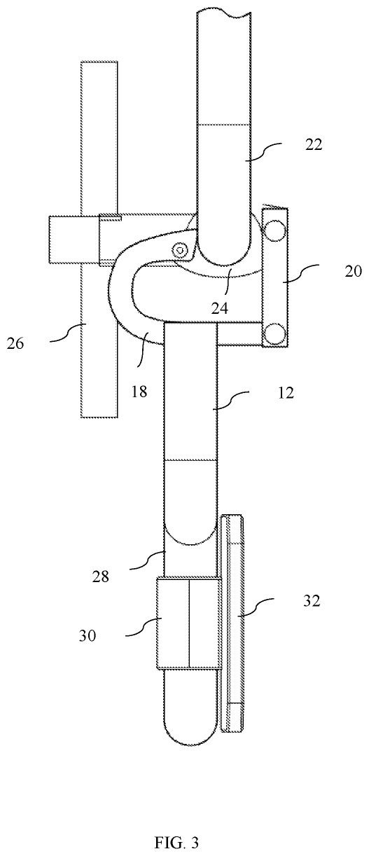

Referring to FIG. 3. In some embodiments of the present invention, the footrest arm 10 may be coupled to a receiving bracket 24 on a frame 22 (sometimes referred to more specifically as a frame tube) of the wheelchair. The curved bracket 18 of the footrest arm 10 may be attached to or manufactured to be a part of the top portion 12 of the footrest arm 10, coupled with the receiving bracket 24 of the frame 22, and have an attached position locking mechanism 20. The frame 22 of the wheelchair that couples with the footrest arm 10 may sometimes align with a wheel 26 of the wheelchair. In the illustrated embodiment, the curved bracket 18 forms a “J” shape. This shape, and substantially similar shapes, has an interior portion that may wrap around the frame 22 of the wheelchair allowing the footrest arm 10 to be swiveled to beneath the seat of the wheelchair. This stowed position is desirable because it allows the rider to easily exit the wheelchair without having to worry about the footrest arm 10 swinging around and hitting or obstructing the rider. Additionally, in further embodiments, the footrest arm 10 may have a means for being locked in the stowed position to prevent undesired swiveling and also for storage of the wheelchair. In further embodiments, the curved bracket 18 may be constructed to prevent the footrest arm 10 from rotating outwards to the exterior of the wheelchair. This may be done (as shown in the figure) by a simple modification to the tip of the curved bracket 18 which contacts the frame 22 of the wheelchair and prevents further outward rotation because of that contact point. In further embodiments, this contact point may have a rubber stopper as to prevent damage to the paint or frame 22 of the wheelchair due to undesired metal-on-metal contact.

In some embodiments, the footrest arm 10 has a bottom portion 28 that connects to a pedal bracket 30 that secures a pedal 32 (shown in the raised position). When in the engaged position, this bottom portion 28 will, in some embodiments, follow the forward direction of the wheelchair so that the pedal 32 is perpendicular to the bottom portion 28, allowing the pedal 32 to be upright or lowered into a position that allows the rider to rest their foot on that pedal 32. In further embodiments, the actuation of the pedal 32 is accomplished by the pedal bracket 30 having a means for allowing the pedal to be rotated into a vertical position (aligning parallel to a rider's leg) and into a horizontal position (allowing the rider to rest their foot on the pedal 32). In even further embodiments, the pedal 32 may retain its position by common mechanisms used in known embodiments of wheelchair footrests such as a metal stopper, friction or compression of pedal bracket 30 and/or pedal 32, a rachet and release system, a pin and hole, or other suited means for manipulating an adjustable, lightweight components.

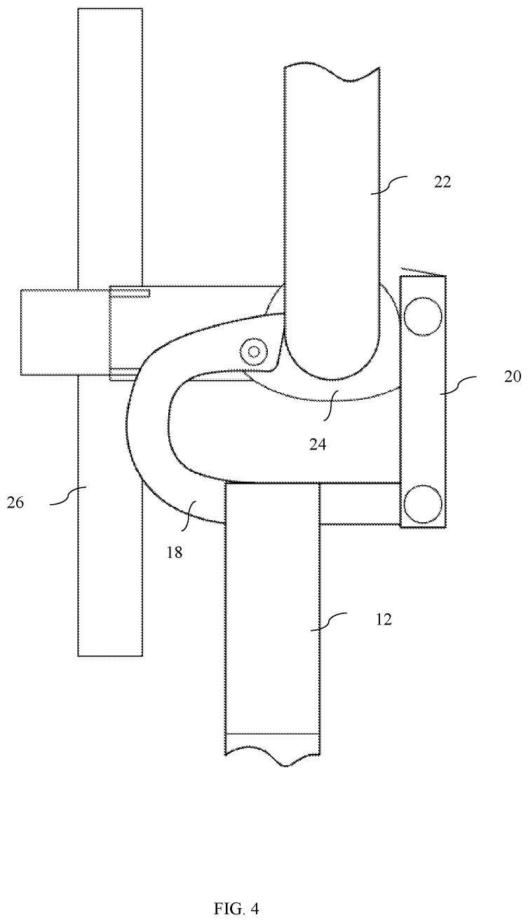

Referring to FIG. 4. In some embodiments of the present invention, the receiving bracket 24, which is attached to the frame 22, couples to the curved bracket 18 via a pin or plug on the receiving bracket 24 that goes through a hole in the curved bracket 18. This connection may be further secured to prevent the footrest arm 10 from undesirably detaching from the wheelchair. One such additional securing of the footrest arm 10 could be a retainer clip or pin that goes through a hole in the pin or plug of the receiving bracket 24 and above the curved bracket 18. The position locking mechanism 20 may be attached to the curved bracket 18 via a bolt or screw.

In some embodiments, the position locking mechanism 20 may be retained by a spring, band, or other means that applies force that pushes the unattached end of the position locking mechanism 20 towards the shorter end of the “J” shaped curved bracket 18 (somewhat resembling a force pushing the moveable portion of a carabiner). Alternatively, the position locking mechanism 20 may have a coil or spring surrounding the bolt or screw that also applies this retention force that pushes the unattached end of the position locking mechanism 20 towards the shorter end of the “J” shaped curved bracket 18. This retention force may be halted by a limiter that does not allow the position locking mechanism 20 to go beyond a certain rotation towards the curved bracket 18. In some embodiments, the limiter could be a raised piece of the curved bracket 18. The position locking mechanism 20, has a cavity on the side that faces the receiving bracket 24 which allows the receiving bracket 24 to partially insert into the position locking mechanism 20. Once the receiving bracket is partially inside the position locking mechanism 20 the footrest arm 10 is considered secured. In further embodiments, the position locking mechanism 20 may have an additional locking mechanism such as a pin that is flexible (possibly made of rubber) or spring-loaded and is displaced and then seated within a hole in the receiving bracket 24, establishing the locking mechanism. In some embodiments, the position locking mechanism 20 may be released so that the footrest arm 10 may be swiveled about the connection between the receiving bracket 24 and the curved bracket 18. One example of such a release is by pulling the end of the position locking mechanism 20 that is not attached to the curved bracket 18 away from the receiving bracket 24. In further embodiments, the position locking mechanism 20 may require a certain amount of force, a button press, a lever actuation, or a clip removed prior to pulling the position locking mechanism 20 away from the receiving bracket 24.

In some embodiments, the secondary support bar 16 may be rotatably attached to a second receiving bracket on the frame 22 of the wheelchair. The second receiving bracket would be positioned below the first receiving bracket 24 to align with the secondary support bar's 16 curved bracket 18. This secondary support bar 16 may or may not also include its own position locking mechanism 20 and its own cavity to receive the second receiving bracket as the footrest arm 10 rotates to the stowed position. If the top portion 12 of the footrest arm 10 telescopes, then the secondary support bar 16 may also be telescope as to not skew the angle of the footrest arm 10 to an undesired orientation in relation to the frame 22.

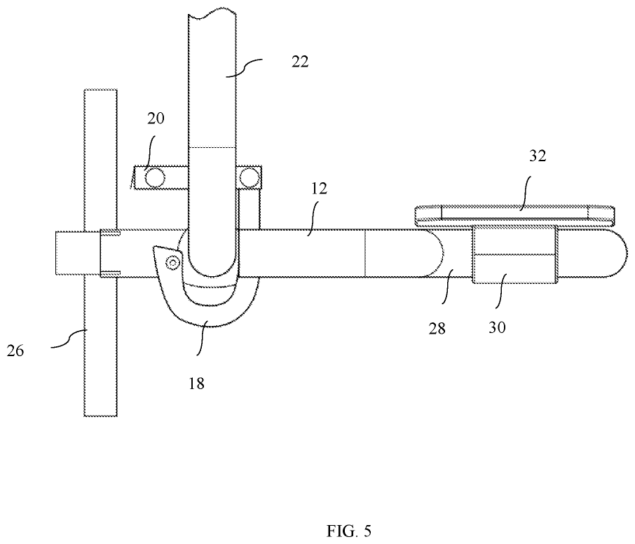

Referring to FIG. 5. In some embodiments the footrest arm 10 may be rotated beneath the wheelchair into a stowed position that is perpendicular to the frame 22 and wheel 26 of the wheelchair. The curved bracket 18 may compliment the shape of the frame 22 and/or the receiving bracket 24 in order to be configured in this stowed position. Additionally, in some embodiments, the curved bracket 18 may include a cavity which the receiving bracket 24 fits within similar to how it does with the position locking mechanism 20. Again, like the position locking mechanism 20 and the receiving bracket 24, the footrest arm 10 may be locked into place until a release mechanism such as a certain amount of force, a button press, a lever actuation, or a clip is removed to allow the footrest arm 10 to swivel about the frame 22. In some embodiments, the frame 22 of the wheelchair may have sufficient space beneath the seat of the wheelchair so that the footrest arms will not make contact with any support beams or other portions of the frame 22 during the collapse and storage of the wheelchair.

In alternative embodiments of the present invention, an improved set of footrests are permanently attached to a wheelchair having at least a frame with attached components including a seat, a back support member, and a plurality of wheels. The difference between these alternative embodiments and the ones described above are that the set of footrests are not easily detachable from the frame of the wheelchair. Such embodiments may be desirable for further lowering the concern of losing detachable footrests.

In some embodiments of the present invention, the set of wheelchair footrests and frame of the wheelchair are made of durable, lightweight materials such as metal tubes. Additionally, the footrest arms and/or footrest pedals may include cushions and/or straps to aide in the comfort and securing of the rider.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An improved set of wheelchair footrests comprising:
a right footrest and a left footrest; and
each footrest comprising a footrest arm and a footrest pedal:
each footrest arm having a vertical portion, a top portion, and a bottom portion;
the vertical portion being connected to the top portion on one end and to the bottom portion on the opposite end;
the top portion of each footrest arm having a curved bracket configured to rotatably attach to a wheelchair's frame at a receiving bracket, said curved bracket being configured to rotate the footrest arm about the wheelchair's frame into a stowed position beneath the wheelchair, and said curved bracket also being configured to rotate and lock the footrest arm about the wheelchair's frame into an engaged position via a position locking mechanism; and
the bottom portion of each footrest arm being coupled to the footrest pedal.

2. The improved set of wheelchair footrests of claim 1 wherein at least one of the vertical portion, the top portion, and the bottom portion are extendable.

3. The improved set of wheelchair footrests of claim 2 wherein each footrest pedal is configured to pivot about at least one axis to a flat position suitable for the rider to rest their foot on and to an upright position.

4. The improved set of wheelchair footrests of claim 3 wherein the curved bracket further comprises an additional locking mechanism that locks the footrest arm in the stowed position beneath the wheelchair.

5. The improved set of wheelchair footrests of claim 4 wherein the curved bracket is additionally rotatable to an outward position having the footrests positioned to their corresponding exterior sides of the wheelchair.

6. The improved set of wheelchair footrests of claim 1 wherein the curved bracket of each footrest arm is configured to detach from the wheelchair frame.

7. The improved set of wheelchair footrests of claim 1 further comprising a secondary support bar attached to the vertical portion of the footrest arm below the top portion and having a secondary curved bracket that rotatably attaches to a secondary receiving bracket on the wheelchair's frame.

8. A wheelchair with an improved set of footrests comprising:
a frame;
a seat attached to the frame;
a back support member attached to the frame;
a plurality of wheels rotatably attached to the frame;
a right footrest and a left footrest; and
each footrest comprising a footrest arm and a footrest pedal:
each footrest arm having a vertical portion, a top portion, and a bottom portion;
the vertical portion being connected to the top portion on one end and to the bottom portion on the opposite end;
the top portion of each footrest arm having a curved bracket configured to rotatably attach to the frame at a receiving bracket, said curved bracket being configured to rotate the footrest arm about the frame into a stowed position beneath the wheelchair, and said curved bracket also being configured to rotate and lock the footrest arm about the frame into an engaged position via a position locking mechanism; and
the bottom portion of each footrest arm being coupled to the footrest pedal.

9. The wheelchair of claim 8 wherein at least one of the vertical portion, the top portion, and the bottom portion are extendable.

10. The wheelchair of claim 9 wherein each footrest pedal is configured to pivot about at least one axis to a flat position suitable for the rider to rest their foot on and to an upright position.

11. The wheelchair of claim 10 wherein the curved bracket further comprises an additional locking mechanism that locks the footrest arm in the stowed position beneath the wheelchair.

12. The wheelchair of claim 11 wherein the curved bracket is additionally rotatable to an outward position having the footrests positioned to their corresponding exterior sides of the wheelchair.

14. The wheelchair of claim 8 further comprising a secondary support bar attached to the vertical portion of the footrest arm below the top portion and having a secondary curved bracket that rotatably attaches to a secondary receiving bracket on the frame.

15. A method for attaching and using an improved set of wheelchair footrests, the method comprising:
attaching a set of wheelchair footrests capable of rotating to a stowed position beneath a seat of a wheelchair via connecting at least one curved bracket of the wheelchair footrests to at least one receiving bracket on a wheelchair's frame;
rotating the wheelchair footrests about the wheelchair's frame into an engaged position for use by a rider;
locking, via a position locking mechanism, the wheelchair footrests in the engaged position;
the rider sitting and moving in the wheelchair; and
when it is desired to exit the wheelchair, rotating the wheelchair footrests beneath the seat of the wheelchair to the stowed position.

16. The method of claim 15 wherein another person aides the movement of the wheelchair after the rider sits in the wheelchair.

17. The method of claim 15 wherein the wheelchair footrests lock into the stowed position via the position locking mechanism.
